(19) United States
(12) Patent Application Publication
(10) Pub. No.: US 2004/0150571 A1
(43) Pub. Date: Aug. 5, 2004

(54) Printed antenna assembled inside the case of a host computer

(76) Inventor: Ten-Long Deng, Hsinchu Hsien (TW)

Correspondence Address: BIRCH STEWART KOLASCH & BIRCH, PO BOX 747, FALLS CHURCH, VA, 22040-0747, US

(21) Appl. No.: 10/747,075

(22) Filed: Dec. 30, 2003

(30) Foreign Application Priority Data
Dec. 31, 2002 (TW) 091221684

(51) Int. Cl. H01Q 1/24

(52) U.S. Cl. 343/702; 343/700 MS

(57) ABSTRACT

An antenna structure for use in a host computer including a case having an opening. The antenna structure includes a plate and a PCB antenna. The plate is coupled to the case for covering the opening. The PCB antenna is provided on the plate and including an antenna pattern and a circuit signally-connected with the antenna pattern.

### FIELD OF THE INVENTION

The present invention relates to a printed antenna assembled inside the case of a host computer, more particularly, to a design of assembling a PCB antenna assembled inside the front panel of the case of a desktop computer.

### BACKGROUND OF THE INVENTION

With rapid development and progress of electronic technology, desktop computers of a new generation provide a powerful operation function and are widely used in a company and personal consumers. Moreover, internal networks are constructed in many companies or industries by installing cables and servers so as to effectively connect those computers and communicate or exchange various information and data. However, wired networks are expensive in design and layout, and construction and wiring of the wired networks frequently cause damage to rented office buildings, and densely spread wire lines are too complicated to manage and maintain. Therefore, wireless networks have been used in many companies or industries to construct the desired internal networks.

Referring to FIG. 1, for a typical wireless network connection, an antenna apparatus 12 is connected onto a host computer 10 and is oriented toward the direction of a wireless access point so as to carry out wireless transmission of data and information. As shown in FIG. 1, the attached antenna apparatus 12 can be placed on the top of the case of the host computer 10 and is connected to a universal serial bus (USB) slot on the back panel of the case of the host computer 10 with a USB cable 14 so as to decode the information received by the antenna apparatus 12 and transmit it to the host computer 10. In addition to the connection of the antenna apparatus 12 to the back of the host computer 10, as shown in FIG. 2, a USB cable 18 is made on the front panel of the case of another host computer 18 and an antenna apparatus 20 is directly inserted into the USB cable 18 to achieve signal connections.

An external antenna apparatus is connected to the case of a host computer in attachment, no matter whether such an antenna apparatus is connected to the slot on the back panel of the case of the host computer or is directly inserted into the slot on the front panel of the case of the host computer to produce wireless connection. However, such an attached construction results in quite a few problems. For example, as shown in FIG. 1, the antenna apparatus 12 is connected to the host computer 10 with the USB cable 14. Although the antenna apparatus 12 can be placed on the top of the case of the host computer or elsewhere depending on the needs or preferences of a user, the antenna apparatus 12 might get toppled or the USB cable 14 might be hooked to have the antenna apparatus 12 thrown down and broken because the user is mindless. Furthermore, as shown in FIG. 2, although the antenna apparatus 20 is directly attached onto the front panel of the host computer without the aid of the USB cable 14, the antenna apparatus 20 is liable to be knocked and pressed because the user often opens the disc tray of an optic disc drive on the front panel of the host computer to put in/take out an optical disc. Hence, it leads the antenna apparatus 20 to crack or malfunction.

### SUMMARY OF THE INVENTION

The objective of the present invention is to provide a manner of assembling an antenna structure in the frame of the case of a host computer so as to effectively prevent the antenna structure from damage due to the consumer's neglect and to further improve the space utilization of the frame of the host computer.

The second objective of the present invention is to provide a manner of assembling an antenna structure on the backside of the front panel of the case of a host computer.

An antenna structure for use in a host computer including a case having an opening. The antenna structure includes a plate and a PCB antenna. The plate is coupled to the case for covering the opening. The PCB antenna is provided on the plate and including an antenna pattern and a circuit signally-connected with the antenna pattern.

An antenna structure for use in a host computer including a case having an opening. The antenna structure includes a plate and a PCB antenna. The plate is coupled to the case for covering the opening. The PCB antenna is provided on the plate and including an antenna pattern and a circuit signally-connected with the antenna pattern.

In the host computer, there are a main room for receiving a motherboard and several accommodating spaces for respectively receiving a peripheral device such as an optic disc drive, a CD-RW drive or a hard disc drive in the frame of the case of the host computer. The PCB antenna includes an antenna pattern and a circuit fabricated on a printed circuit board. Two clasp sections are respectively mounted to two ends of the printed circuit board and have a respective hole. Moreover, two ends of a bus line are respectively connected to the PCB antenna and the motherboard for transmitting and exchanging signals. The PCB antenna is placed in the accommodating space and the PCB antenna is fixed by respectively locking the clasp sections to the side walls of the accommodating space with screws.

Furthermore, this invention also provides a host computer for wireless transmission. The host computer has a case having a front panel mounted in front of the frame of the host computer. The front panel has several removable rectangular plates. A PCB antenna is positioned at the backside of one of the rectangular plates and includes an antenna pattern and a circuit fabricated on a printed circuit board. A socket 522 is set on the printed circuit board into which a transmission cable such as a digital transmission cable is inserted, and thus the PCB antenna can be connected to a motherboard of the host computer for signal transmission.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic diagram illustrating a first attached antenna apparatus applied in wireless network in the prior art;

FIG. 2 is a schematic diagram illustrating a second attached antenna apparatus applied in wireless network in the prior art;

FIG. 3 is a schematic diagram illustrating an antenna structure assembled in a host computer in accordance with this invention;

FIG. 4 is a schematic diagram illustrating the layout of the frame of the case of a typical desktop computer;

FIG. 5 is a schematic diagram illustrating a manner of assembling an antenna structure in the frame of the case of a host computer in accordance with this invention;

FIG. 6 is a schematic diagram of assembling and locking the antenna structure together with a hard disc drive in the same accommodating space in accordance with this invention;

FIG. 7 is a schematic diagram of assembling the front panel to the frame of the case of the host computer in accordance with this invention, wherein the antenna structure assembled in the accommodating space is behind the front panel of the case and is sheltered by a removable rectangular plate; and

FIG. 8 is a schematic diagram of assembling the antenna structure on the backside of the rectangular plate in a second embodiment in accordance with this invention.

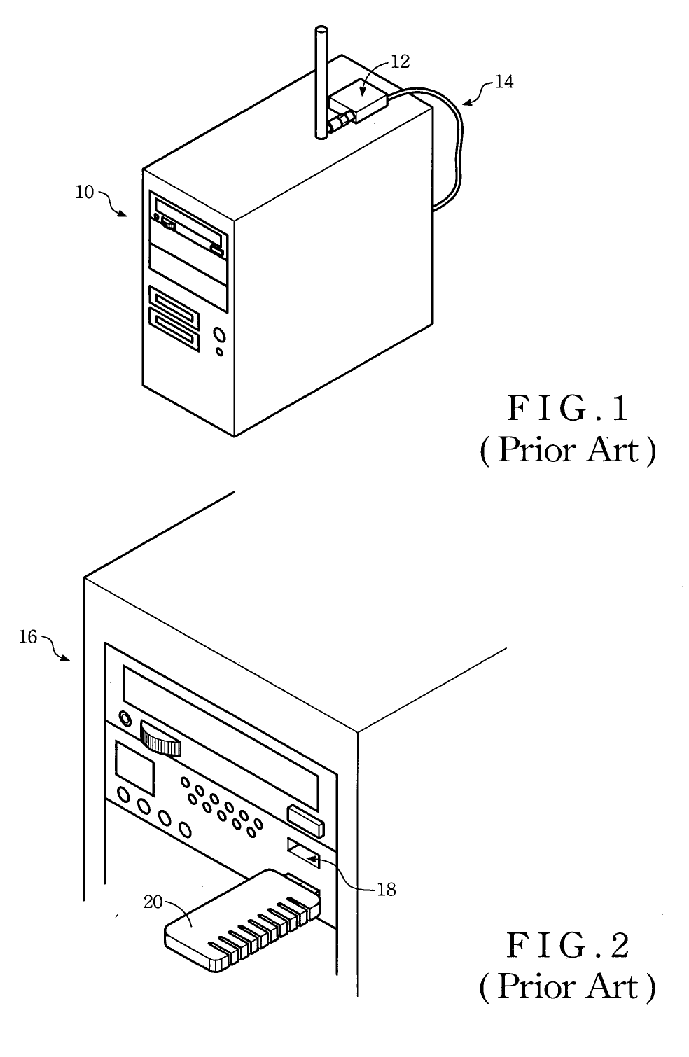

### DETAILED DESCRIPTION OF THE PREFERRED EMBODIMENT

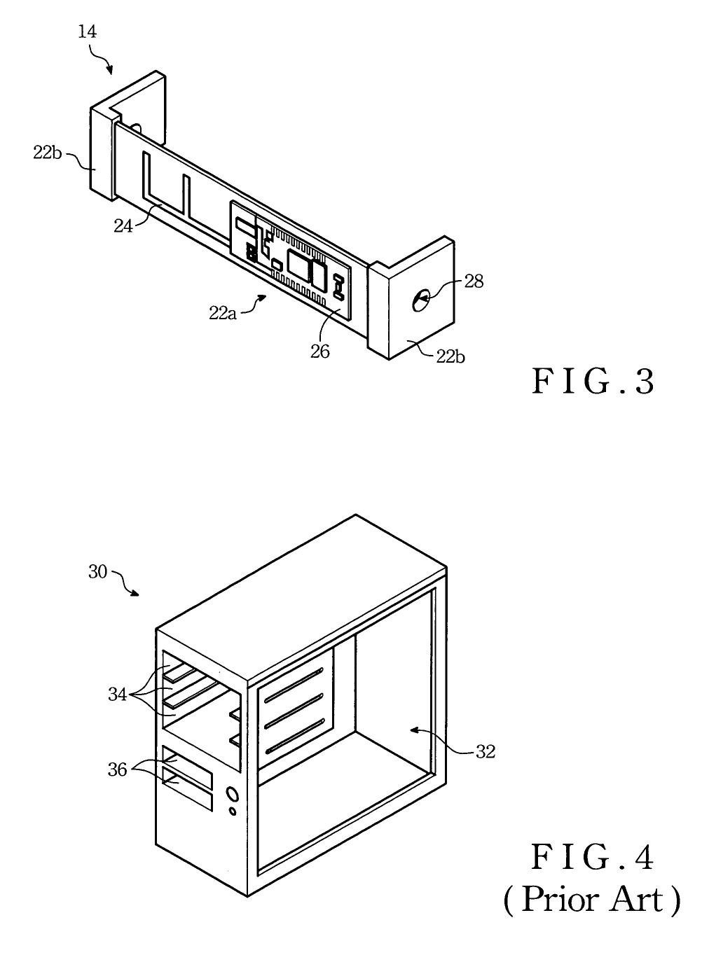

Please refer to FIG. 3, which is a schematic diagram illustrating an antenna structure 22 assembled in a host computer in accordance with this invention. The antenna structure 22 includes a PCB antenna 22a and two clasp sections 22b. The PCB antenna 22a includes an antenna pattern 24 and a circuit 26, such as a decoder circuit, fabricated on a printed circuit board. The two clasp sections 22b are respectively connected to one respective end of the PCB antenna 22a and each of the clasp sections 22b has one hole 28 for a screw to lock. Preferably, each of the clasp sections 22b is a plate of “L” shape. The end of the PCB antenna 22a is telescoped into one part of the plate and the other part of the plate has the hole 28.

Please refer to FIG. 4, which is a schematic diagram illustrating a typical frame 30 of the case of a desktop computer. It is well known that the motherboard of such a desktop computer is received in a main room 32 inside the frame 30 having several large accommodating spaces 34 for receiving peripheral devices of 5¼ inches such as an optic disc drive, a CD-RW drive and a hard disc drive are placed in the front portion of the frame 30. Small accommodating spaces for receiving peripheral devices of 3 1/2 inches such as a floppy disc drive are placed below those large accommodating spaces 34.

Please refer to FIG. 5, which is a schematic diagram of assembling the antenna structure 22 in the frame 30. When the PCB antenna 22a is placed into the front portion of a first large accommodating space 34, screws 38 are passed through the openings of side walls of the first large accommodating space 34 and screwed into the holes 28 of the clasp sections 22b so as to have the antenna structure 22 locked onto the side walls of the first large accommodating space 34. For comparison, an optic disc drive 40 is assembled in a second large accommodating space 34 as shown in FIG. 5. The optic disc drive 40 is locked in the second large accommodating space 34 by screws 42, and the power cable and the signal cable on the motherboard are connected to the optic disc drive 40 for operation.

Since the PCB antenna 22a itself includes the antenna pattern 24 and the circuit 26, the PCB antenna 22a is connected to the motherboard with a line such as USB for transmitting and exchanging digital signals.

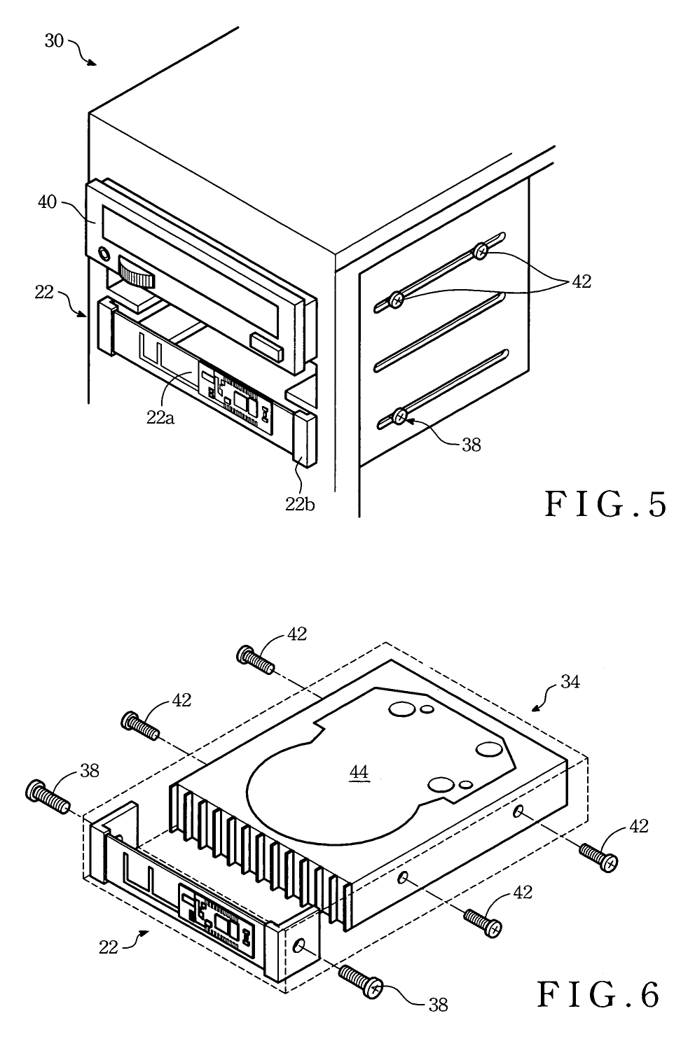

Furthermore, in a preferred embodiment, the antenna structure 22 occupies less space and can be placed in the same accommodating space together with a hard disc drive 44. As shown in FIG. 6, the antenna structure 22 is locked in the front portion of the accommodating space 34 by screws 38 and the hard disc drive 44 is placed in the rear portion thereof and is locked by screws 42.

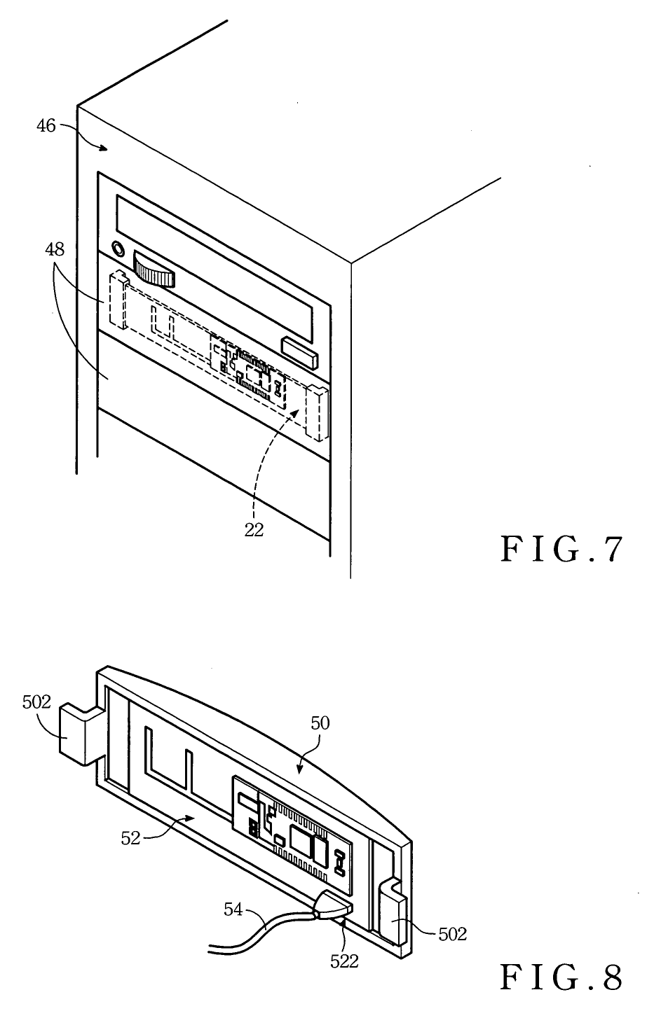

Please refer to FIG. 7, which is a schematic diagram illustrating the frame 30 of the host computer after it has been assembled with panels. It is well known that generally, several removable rectangular plates 48 are located on a front panel 46 of the host computer to cover or hide the opening of the accommodating space 34 or 36 before the peripheral device is installed into the host computer. Once the peripheral device such as the optic disc drive 40 or the CD-RW drive are installed into the large accommodating spaces 34 of the frame 30, the rectangular plates 48 in front of the accommodating spaces 34 are removed so as to expose the operation panels of the optic disc drive 40 and the CD-RW drive. Alternatively, when the hard disc drive is assembled in the large accommodating space 34, the rectangular plate 48 in front of the accommodating space 34 is remained for protection and visual pleasure. In the aforesaid example of this invention, since the antenna structure 22 assembled in the front portion of the accommodating space 34 is not to be exposed, the related rectangular plate 48 in front of the accommodating space 34 is remained to cover and thus protect the antenna structure 22. As shown in FIG. 7, the antenna structure 22 assembled in the same accommodating space 34 together with the hard disc drive 44 is sheltered by the rectangular plate 48.

In addition to assembling the antenna structure 22 in the accommodating space 34, the PCB antenna can be directly fabricated on the backside of the rectangular plate. Referring to FIG. 8, a PCB antenna 52 is fabricated on the backside of a rectangular plate 50. The PCB antenna 52 includes an antenna pattern and a circuit fabricated on a printed circuit board and is connected to the motherboard of the computer (not shown) with a digital transmission cable 54 such as USB cable so as to transmit information and data. As shown in FIG. 8, a socket 522 is set on the PCB antenna 52 into which the transmission cable 54 is inserted, and thus the PCB antenna 52 can be connected to the motherboard. A protruded hook 502 is respectively fabricated on the two ends of the rectangular plate 50 so as to clip the rectangular plate 50 over opening of the front panel 46 of the case. When the PCB antenna 52 is broken, the original rectangular plate 50 can be directly replaced with another rectangular plate 50 having a PCB antenna 52.

There are many advantages in this invention to lock the antenna structure in the case of the computer. First, since the antenna structure is designed inside the case of the computer, it can prevent the consumers from toppling and even breaking the attached antenna. Moreover, the antenna structure in this invention can be assembled together with the hard disc in the same accommodating space and an additional accommodating space is spared to receive the antenna structure. In addition, in the second embodiment of this invention, since the PCB antenna is directly fabricated on the backside of the rectangular plate at the front panel of the case, a new PCB antenna can be replaced by dismantling the rectangular plate and substituting a new one.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What I claimed:

1. An antenna structure for use in a host computer, the host computer including a case having an opening, the antenna structure comprising:
a plate coupled to the case for covering the opening; and
a PCB antenna provided on the plate and including an antenna pattern and a circuit signally-connected with the antenna pattern.

2. The antenna structure according to claim 1, wherein the opening is for accommodating a peripheral device of the host computer.

3. The antenna structure according to claim 2, wherein the peripheral device is selected from the group consisting of an optical disc drive, a CD-RW drive and a hard disc drive.

4. The antenna structure according to claim 1, wherein the PCB antenna is signally-connected to a motherboard in the host computer with a transmission cable.

5. The antenna structure according to claim 4, wherein the transmission cable is a USB cable.

6. The antenna structure according to claim 1, wherein the circuit is a decoder circuit.

7. The antenna structure according to claim 1, wherein the plate is coupled to the case by screwing.

8. The antenna structure according to claim 7, wherein the plate includes a clasp section having a hole for screwing.

9. The antenna structure according to claim 8, wherein the clasp section is in an L shape.

10. The antenna structure according to claim 1, wherein the plate is coupled to the case by clasping.

11. The antenna structure according to claim 10, wherein the plate includes a clasp section for clasping the plate to the edge of the opening.

12. The antenna structure according to claim 1, wherein the PCB antenna is at the inside of the case when the plate is coupled to the case.

13. The antenna structure according to claim 1, wherein the PCB antenna is at the outside of the case when the plate is coupled to the case.

14. An antenna structure assembled in a host computer, wherein said host computer has a case having a front panel and said front panel has at least a removable plate, said antenna structure comprising:
a PCB antenna, positioned at the backside of said plate and including an antenna pattern and a circuit.

15. The antenna structure of claim 14, wherein said PCB antenna is connected to said host computer with a transmission cable.

16. The antenna structure of claim 15, wherein said transmission cable is a USB cable.

17. The antenna structure of claim 14, wherein an accommodating space for receiving a peripheral device is provided behind said rectangular plate.

18. The antenna structure of claim 17, wherein said peripheral device is selected from the group consisting of an optic disc drive, a CD-RW drive and a hard disc drive.

19. The antenna structure of claim 14, wherein said rectangular plate is combined to said case of said host computer by at least a screw.

20. A host computer having an antenna structure, comprising:
a case, having an opening;
a plate used to cover the opening; and
a PCB antenna, formed on the plate.
